(19) United States
(12) Patent Application Publication
(10) Pub. No.: US 2023/0108248 A1
(43) Pub. Date: Apr. 6, 2023

(54) MODEL COMPRESSION VIA QUANTIZED SPARSE PRINCIPAL COMPONENT ANALYSIS

(71) Applicant: QUALCOMM Incorporated, San Diego, CA (US)

(72) Inventors: Andrey KUZMIN, Hilversum (NL); Marinus Willem VAN BAALEN, Amsterdam (NL); Markus NAGEL, Amsterdam (NL); Arash BEHBOODI, Amsterdam (NL)

(21) Appl. No.: 17/960,052

(22) Filed: Oct. 4, 2022

Related U.S. Application Data
(60) Provisional application No. 63/252,491, filed on Oct. 5, 2021.

(51) Int. Cl. G06N 3/08; G06N 3/04

(52) U.S. Cl. CPC G06N 3/08; G06N 3/04

(57) ABSTRACT

A processor-implemented method includes retrieving, for a layer of a set of layers of an artificial neural network (ANN), a dense quantized matrix representing a codebook and a sparse quantized matrix representing linear coefficients. The dense quantized matrix and the sparse quantized matrix may be associated with a weight tensor of the layer. The processor-implemented method also includes determining, for the layer of the set of layers, the weight tensor based on a product of the dense quantized matrix and the sparse quantized matrix. The processor-implemented method further includes processing, at the layer, an input based on the weight tensor.

### CROSS-REFERENCE TO RELATED APPLICATIONS

The present application claims the benefit of U.S. Provisional Patent Application No. 63/252,491, filed on Oct. 5, 2021, and titled “MODEL COMPRESSION VIA QUANTIZED SPARSE PRINCIPAL COMPONENT ANALYSIS,” the disclosure of which is expressly incorporated by reference in its entirety.

### BACKGROUND

### Field

Aspects of the present disclosure generally relate to compressing a neural network model.

### Background

Artificial neural networks may comprise interconnected groups of artificial neurons (e.g., neuron models). The artificial neural network may be a computational device or represented as a method to be performed by a computational device. Convolutional neural networks, such as deep convolutional neural networks, are a type of feed-forward artificial neural network. Convolutional neural networks may include layers of neurons that may be configured in a tiled receptive field.

Deep neural networks, such as deep convolutional neural networks, have achieved state of the art results in a wide variety of tasks. In most cases, deep neural networks consume a large amount of resources, such as computational, power, and/or memory resources. Transferring weight data in deep neural networks may be a significant contributor to both inference time resource consumption and latency. During the transfer of weight data, processing cores of a device associated with the deep neural network may be idle as weights of the deep neural network are transferred from off-chip to on-chip memory of the device.

### SUMMARY

In one aspect of the present disclosure, a processor-implemented method includes retrieving, for a layer of an artificial neural network, a codebook matrix representing a codebook and a latent matrix representing linear coefficients. The processor-implemented method further includes determining, for the layer, the weight tensor based on a product of the codebook matrix and the latent matrix. The processor-implemented method still further includes processing, at the layer, an input based on the weight tensor.

Another aspect of the present disclosure is directed to an apparatus including means for retrieving, for a layer an artificial neural network, a codebook matrix representing a codebook and a latent matrix representing linear coefficients. The apparatus further includes means for determining, for the layer, the weight tensor based on a product of the codebook matrix and the latent matrix. The apparatus still further includes means for processing, at the layer, an input based on the weight tensor.

In another aspect of the present disclosure, a non-transitory computer-readable medium with non-transitory program code recorded thereon is disclosed. The program code is executed by a processor and includes program code to retrieve, for a layer of a set of layers of an artificial neural network, a codebook matrix representing a codebook and a latent matrix representing linear coefficients. The program code further includes program code to determine, for the layer, the weight tensor based on a product of the codebook matrix and the latent matrix. The program code still further includes program code to process, at the layer, an input based on the weight tensor.

Another aspect of the present disclosure is directed to an apparatus having a processor, and a memory coupled with the processor and storing instructions operable, when executed by the processor, to cause the apparatus to retrieve, for a layer of an artificial neural network, a codebook matrix representing a codebook and a latent matrix representing linear coefficients. Execution of the instructions also cause the apparatus to determine, for the layer, the weight tensor based on a product of the codebook matrix and the latent matrix. Execution of the instructions further cause the apparatus to process, at the layer, an input based on the weight tensor.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying Figures. Each of the Figures is provided for the purposes of illustration and description, and not as a definition of the limits of the claims.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an example of approximating an original weight tensor, in accordance with various aspects of the present disclosure.

FIG. 5 illustrates a flow diagram illustrating an example process for an artificial neural network, in accordance with some aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Deep neural networks (DNNs) may be used in a variety of tasks on a variety of devices. In most cases, DNNs consume a large amount of resources of a device, such as computational, power, and/or memory resources. Therefore, deployment of a DNN on some devices remains challenging due to limited resources of such devices. For example, edge devices such as mobile devices and Internet-of-Things (IoT) devices may be subject to computational and memory constraints. Thus, it may be difficult to deploy a DNN on an edge device because an amount of computational power and/or memory use of the DNN may be greater than an amount of computational power and/or memory available at the edge device. In contrast, a DNN deployed on a cloud computing system may not be subject to computational and memory constraints. Still, cloud computing systems may increase latency of the DNN and/or increase power consumption associated with the DNN. DNNs may also be referred to as deep networks or deep convolutional neural networks.

In some cases, transferring weight data (e.g., retrieving stored weight data associated with one or more layers) contributes to power consumption and latency during inference. In some examples, one or more processing cores of a device may be idle as weights are being transferred from off-chip of the device to on-chip memory of the device during a weight data transfer. It may be desirable to reduce resources used by an artificial neural network to decrease power consumption and latency. The resources may include memory resources and/or computational resources of a device used to deploy the DNN.

Various aspects disclosed relate generally to tensor factorization. Some aspects more specifically relate to factorizing an original weight tensor to a codebook matrix (e.g., a dense matrix) and a latent matrix (e.g., a sparse matrix), such that the matrix product closely approximates the original weight tensor. In a sparse matrix, a quantity of zero values may be greater than a quantity of non-zero values. During inference, the matrix product may be computed, and the result may be used for computations at a layer associated with the original weight tensor. In some examples, a matrix product may be computed per layer, as each layer processes an input. In other examples, multiple matrix products may be computed prior to processing an input at the layers of the neural network. In such examples, each layer may be associated with a respective matrix product of the multiple matrix products.

Particular aspects of the subject matter described in this disclosure may be implemented to realize one or more of the following potential advantages. In some examples, the described techniques may reduce latency by reducing an amount of weight data transfers. In such examples, cores that may have been idle during a weight data transfer may be allocated to generating layer weights, for each layer, based on a matrix product corresponding to an original weight associated with the layer.

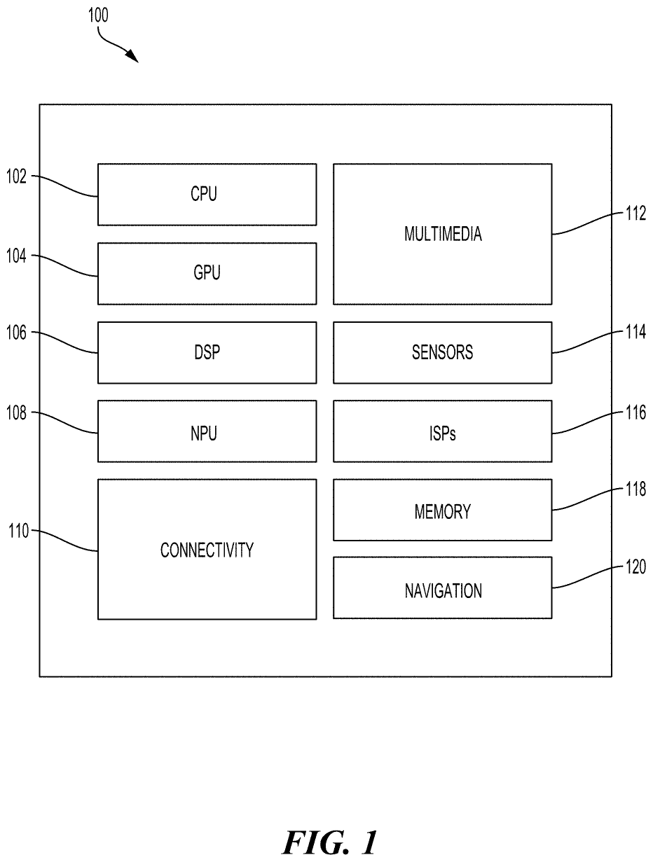

FIG. 1 illustrates an example implementation of a system-on-a-chip (SOC) 100, which may include a central processing unit (CPU) 102 or a multi-core CPU configured for generating a weight tensor based on a dense quantized matrix and a sparse quantized matrix, in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may comprise code to generate, during training of the ANN, the weight tensor based on a transformation of an original weight tensor from a four-dimensional weight tensor to a two-dimensional weight tensor; code to factorize, during the training, the weight tensor to a dense matrix and a sparse matrix; code to quantize, during the training, the dense matrix and the sparse matrix to generate the dense quantized matrix and the sparse quantized matrix; and code to sparsify the sparse quantized matrix.

In some aspects of the present disclosure, the instructions loaded into the general-purpose processor 102 may also comprise code to retrieve, for a layer of a set of layers of the ANN, a dense quantized matrix comprising a codebook and a sparse quantized matrix comprising linear coefficients, the dense quantized matrix and the sparse quantized matrix associated with a weight tensor of the layer; code to determine, for the layer of the set of layers, the weight tensor based on a product of the dense quantized matrix and the sparse quantized matrix; and code to process, at the layer, an input based on the weight tensor

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

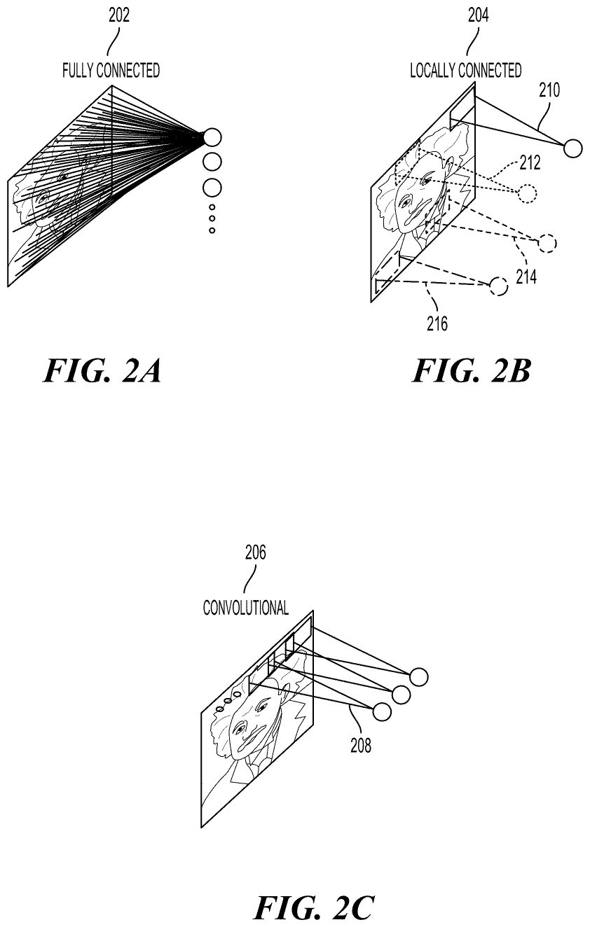

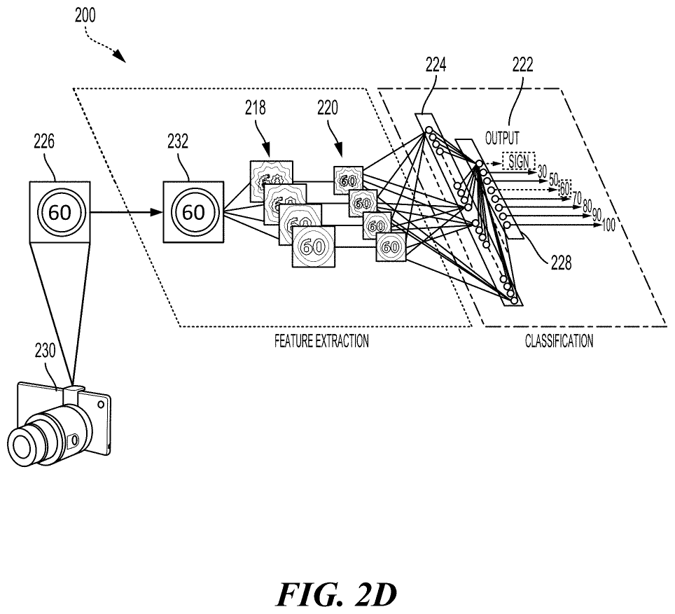

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images (e.g., the speed limit sign of the image 226) and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

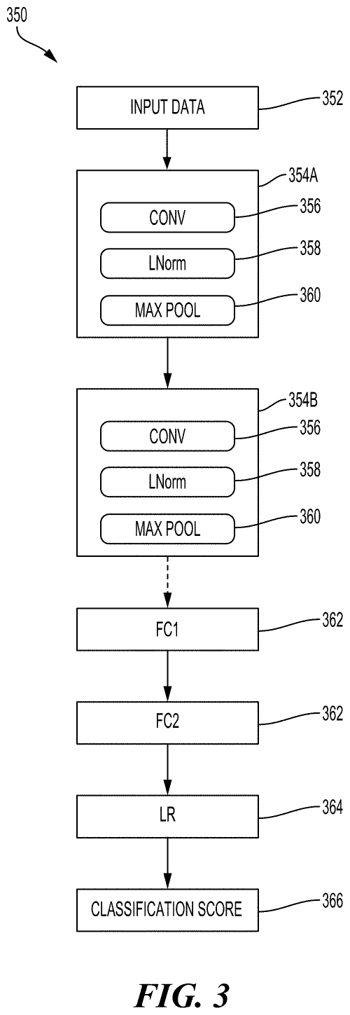

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data, including a feature from a set of features.

As previously discussed, deep neural networks (DNNs) may be used in a variety of tasks on a variety of devices. Deployment of DNNs on some devices remains challenging due to limited resources of such devices. For example, edge devices such as mobile devices and Internet-of-Things (IoT) devices may be subject to computational and memory constraints. Therefore, it may be difficult to deploy a DNN on an edge device because an amount of resources, such as computational power and/or memory resources, used by the DNN may be greater than an amount of resources available at the edge device. In contrast, a DNN deployed on cloud computing systems may not be subject to computational and memory constraints. Still, cloud computing systems may increase latency of the DNN and/or increase an amount of power consumed by the DNN.

In some cases, transferring weight data (e.g., retrieving stored weight data associated with one or more layers) may increase power consumption and latency during inference. In some examples, one or more processing cores of a device may be idle as weight data is transferred from off-chip (e.g., DRAM) of the device to on-chip memory (e.g., tightly coupled memory (TCM) or SRAM) of the device during the transfer of the weight data. It may be desirable to reduce resources used by a DNN to decrease power consumption and/or latency. The resources may include memory resources and/or computational resources, such as a processor resources.

Various aspects disclosed relate generally to tensor factorization. In some implementations, weight tensors may be factorized based on a sparse principal component analysis (PCA) technique. PCA is an example of a data-processing and dimension-reduction technique that seeks linear combinations of original variables, such that derived variables may capture maximal variance. A singular value decomposition (SVD) of a data matrix may be used to determine the PCA. As an example, data X may be represented by an n×p matrix, where a parameter n represents a number of observations and a parameter p represents a number of variables. PCAs may be difficult to interpret because components may be linear combinations of variables p. Sparse PCA may be specified to achieve a dimensionality reduction while also reducing a number of variables.

Some aspects more specifically relate to identifying a factorization of a codebook matrix C and a latent matrix Z associated with an original weight tensor W, such that the matrix product CZ approximates the original weight tensor W. The values of latent matrix Z may be multi-bit. The latent matrix Z may be an example of a sparse quantized matrix and the codebook matrix C may be an example of a dense quantized matrix. Additionally, the latent quantized matrix Z may represent linear coefficients of an approximation of the weight tensor W. The matrix product CZ may be computed during inference, and the result may be used for computations at a layer associated with the original weight tensor. In some examples, a matrix product may be computed per layer, as each layer processes an input. In other examples, multiple matrix products may be computed prior to processing an input at the layers of the neural network. In such examples, each layer may be associated with a respective matrix product of the multiple matrix products.

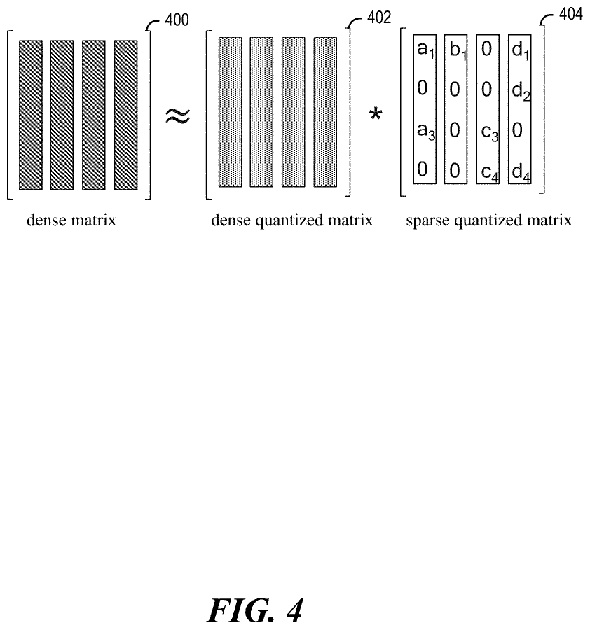

FIG. 4 is a block diagram illustrating an example of approximating an original weight tensor W in accordance with various aspects of the present disclosure. In the example of FIG. 4, the original weight tensor W, where W ∈ [symbol] ^{Fin×Fout×H×W}, of a convolutional layer may be reshaped to a dense matrix \tilde{W} 400, where W ∈ [symbol] ^{N×D}. The dense matrix \tilde{W} 400 may also be referred to as a weight matrix. In some examples, the dense matrix \tilde{W} 400 may be in a float32 format. Fᵢₙ represents a number of input channels, Fₒᵤₜ represents a number of output channels, and H and W represent spatial dimensions of a filter. Additionally, N represents a number of tiles (e.g., N=FᵢₙFₒᵤₜHW/D) and D represents a hyperparameter corresponding to a dimensionality, such as a tile size. The decomposition of every column of the dense matrix \tilde{W} 400 may be a linear combination of k codebook vectors (columns of the codebook matrix C 402):

\tilde{W}_{:,i}Σⱼ₌₁^{k}Zⱼᵢ\tilde{C}_{:,j}, (1)

where \tilde{C}_{:,j} is the j-th column of the codebook matrix C 402.

The quantiziation operation for the codebook matrix C 402 and the latent matrix latent matrix Z may be defined as follows:

C_{q}=Q_{c}(C;s_{c},b_{c}), (2)

Z_{q}=Q_{z}(C;s_{Z},b_{z}), (3)

where b_{c} and b_{z} represent quanization bit-widths, and s_{z} and s_{c} represent quanizatoin scale factors.

In some examples, the dense matrix \tilde{W} 400 may be factorized into a codebook matrix C 402 (C ∈ [symbol] ^{D×k}) associated with a codebook, and a latent matrix Z 404 (Z ∈ [symbol] ^{k×N}) associated with a linear coefficient, such that the dense matrix \tilde{W} 400 is a product of the codebook matrix C 402 and the latent matrix Z 404 (e.g., \tilde{W}=CZ). In some examples, the codebook matrix C 402 and the latent matrix Z 404 may be stored instead of storing a full weight tensor W, thereby reducing a memory footprint of a DNN. Additionally, k<<D, N, where k represents a principle component analysis (PCA) rank that defines a compression rate of a factorization. The codebook matrix C 402 and the latent matrix Z 404 may be quantized to bitwidths B_{C} and B_{Z}, respectively, with B_{C}, B_{Z}«32. That is, the bitwidths B_{C} and B_{Z} define a compression rate of the codebook matrix C 402 and the latent matrix Z 404. In the latent matrix Z 404, a number of zero values may be greater than a number of non-zero values. In some examples, a zero mean version of the original weight tensor W may be factorized. In the example of FIG. 4, dimensions of the dense matrix \tilde{W} 400 may be [d×n], where d<<n. Dimensions of the codebook matrix C 402 may be [d×k], where d>>k, and dimensions of the latent matrix Z 404 may be [k×n]/

In some examples, during training, a weight tensor W may be reshaped into a dense matrix \tilde{W} 400. The dense matrix \tilde{W} 400 may be factorized into a codebook matrix C 402 and a latent matrix Z 404 using a floating point implementation of principle component analysis (PCA). Scales shared per row for the codebook matrix C 402 and per column for the latent matrix Z 404 may be quantized as follows:

$${C}_{ij} = clamp ( ⌊ \frac{{C}_{ij}}{{s}_{i}} ⌉ , 0 , {2}^{b} - 1 ) {s}_{i} \qquad ( 4 )$$

$${Z}_{ij} = clamp ( ⌊ \frac{{Z}_{ij}}{{δ}_{j}} ⌉ , 0 , {2}^{b} - 1 ) {δ}_{j} \qquad ( 5 )$$

In Equations 1 and 2, the variable b represents a bit-width, the variable i represents a row, and the variable j represents a column. In Equation 1, the variable sᵢ represents a quantization scale, and in Equation 2, the variable δᵢ represents a quantization scale. Furthermore, the clamp( )function may be defined as:

$$clamp ( x , a , b ) = \{ \begin{matrix}a & x < a \\ x & a \leq x \leq b \\ b & x > b\end{matrix} \qquad ( 6 )$$

The quantization scales sᵢ and δᵢ may be determined as follows:

$${W}_{ij} \approx {\sum }_{k} {s}_{i} {C}_{ik}^{int} {δ}_{j} {Z}_{kj}^{int} = \frac{{s}_{i} {δ}_{j}}{{s}_{w}} {\sum }_{k} {C}_{ik}^{int} {Z}_{kj}^{int} \qquad ( 7 )$$

During training, the dense quantized matrix C and the sparse quantized matrix Z may be optimized based on input data samples, per layer, to compensate for quantization. In some examples, a straight-through estimator may be used for training quantized weights. That is, during training, the values of the dense quantized matrix C and the latent quantized matrix Z may be adjusted, rather than the values of a weight matrix. The latent quantized matrix Z may be stored in a compressed sparse format to reduce a size of a layer (e.g., reduce memory use). In some examples, magnitude pruning or L0 norm minimization may be used for the sparsification. Still, any unstructured sparsification method may be used. The network may be fine-tuned end-to-end using back-propagation and the original dataset to recover the error after the compression. A straight-through estimator may be used for quantized factors. After training, the dense quantized matrix C and the sparse quantized matrix Z may be stored, per layer, in memory.

During inference, the dense quantized matrix C and the sparse quantized matrix Z may be loaded from memory. Furthermore, a weight tensor W may be estimated based on a product of the dense quantized matrix C and the sparse quantized matrix Z. The neural network may then proceed with the layer computations based on weights obtained from the reconstructed weight tensor W. In some examples, the weight tensor W may be reconstructed per layer to reduce overall memory use. In other examples, all weight tensors W (e.g., for each layer of the neural network) may be reconstructed prior to performing the inference at the neural network.

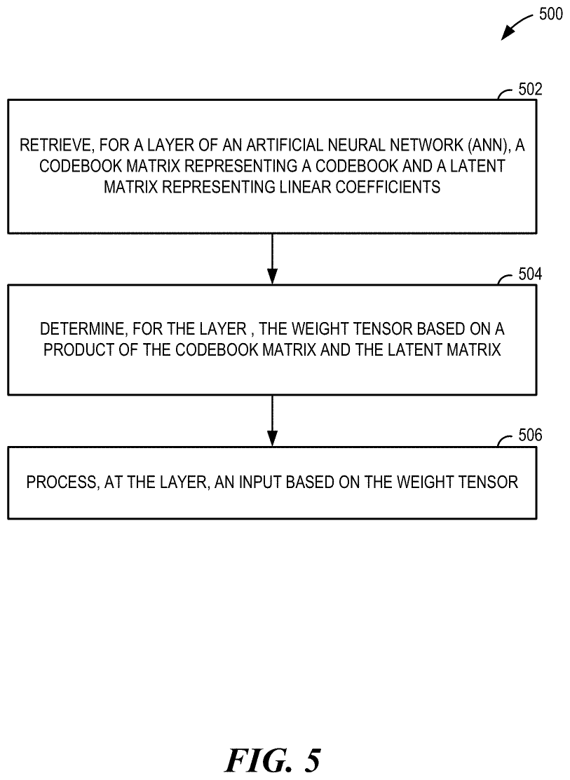

FIG. 5 is a flow diagram illustrating an example process 500 for an artificial neural network (ANN), in accordance with some aspects of the present disclosure. The example process 500 is an example of generating a weight tensor for one or more layers of the artificial neural network based on a codebook matrix and a latent matrix associated with each layer of the one or more layers. The process 500 may be for an artificial neural network, such as the DCN 200 or the DCN 350 described with reference to FIGS. 2 and 3, respectively.

As shown in FIG. 5, at block 502, the ANN retrieves, for a layer of the ANN, a codebook matrix representing a codebook and a latent matrix representing linear coefficients. The codebook matrix and the latent matrix may be stored in a memory associated with a device that implements the ANN. Additionally, the layer may be a convolutional layer or a fully connected layer. Furthermore, the ANN may be a deep convolutional neural network.

At block 504, the ANN determines, for the layer, the weight tensor based on a product of the codebook matrix and the latent matrix. Finally, at block 506, the ANN processes, at the layer, an input based on the weight tensor. The input may be processed by performing a convolution based on weights associated with the weight tensor.

In some examples, the process 500 described in blocks 502, 504, and 506 may be repeated for each remaining layer of the set of layers based on a codebook matrix and a latent matrix associated with a weight tensor of each remaining layer of the set of layers. In other examples, the process 500 may be performed for all layers of the ANN upon initializing the ANN, or prior to processing an input to the ANN.

Implementation examples are described in the following numbered clauses.
Clause 1. A processor-implemented method, comprising: retrieving, for a layer of an artificial neural network (ANN), a codebook matrix representing a codebook and a latent matrix representing linear coefficients; determining, for the layer of the set of layers, the weight tensor based on a product of the codebook matrix and the latent matrix; and processing, at the layer, an input based on the weight tensor.
Clause 2. The processor-implemented method of Clause 1, further comprising repeating the retrieving, the determining, and the processing for each remaining layer of the set of layers based on a codebook matrix and a latent matrix associated with a weight tensor of each remaining layer of the set of layers.
Clause 3. The processor-implemented method of any one of Clauses 1-2, in which processing the input comprises performing a convolution based on weights associated with the weight tensor.
Clause 4. The processor-implemented method of any one of Clauses 1-3, further comprising: generating, during training of the ANN, the weight tensor based on a transformation of an original weight tensor from a four-dimensional weight tensor to a two-dimensional weight tensor; factorizing, during the training, the weight tensor to a dense matrix and a sparse matrix; and quantizing, during the training, the dense matrix and the sparse matrix to generate the dense quantized matrix and the sparse quantized matrix.
Clause 5. The processor-implemented method of Clause 4, further comprising factorizing the weight tensor to the codebook matrix and the latent matrix based on a floating point implementation for principal component analysis (PCA).
Clause 6. The processor-implemented method of any one of clauses 4-5, further comprising optimizing, during the training, the codebook matrix and the latent matrix on training data based on the quantizing.
Clause 7. The processor-implemented method of any one of Clauses 4-6, in which a compression rate of a factorization associated with the codebook matrix is different from a compression rate of a factorization associated with the latent matrix.
Clause 8. The processor-implemented method of any one of Clauses 1-7, in which the codebook matrix and the latent matrix are stored in a memory associated with a device that implements the ANN.
Clause 9. The processor-implemented method of any one of Clauses 1-8, in which the layer is a convolutional layer or a fully connected layer.
Clause 10. The processor-implemented method of any one of Clauses 1-9, in which the ANN is a deep convolutional neural network.
Clause 11. The processor-implemented method of any one of Clauses 1-10, in which the latent matrix is a sparse quantized matrix and the codebook matrix is a dense quantized matrix.
Clause 12. An apparatus implementing an ANN, the apparatus comprising a processor, memory coupled with the processor, and instructions stored in the memory and operable, when executed by the processor to cause the apparatus to perform any one of Clauses 1 through 11.
Clause 13. An apparatus configured for an ANN, the apparatus comprising at least one means for performing any one of Clauses 1 through 11.
Clause 14. A non-transitory computer-readable medium having program code recorded thereon for an artificial neural network, the program code comprising program code to cause an ANN to perform any one of Clauses 1 through 11.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described here may be implemented in hardware, software, firmware, or any combination thereof If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A processor-implemented method, comprising:
retrieving, for a layer of an artificial neural network (ANN), a codebook matrix representing a codebook and a latent matrix representing linear coefficient;
determining, for the layer, a weight tensor based on a product of the codebook matrix and the latent matrix; and
processing, at the layer, an input based on the weight tensor.

2. The processor-implemented method of claim 1, further comprising repeating, for each remaining layer of a set of layers, the retrieving, the determining, and the processing based on a codebook matrix and a latent matrix associated with a weight tensor of each remaining layer of the set of layers.

3. The processor-implemented method of claim 1, in which processing the input comprises performing a convolution based on weights associated with the weight tensor.

4. The processor-implemented method of claim 1, further comprising:
generating, during training of the ANN, the weight tensor based on a transformation of an original weight tensor from a four-dimensional weight tensor to a two-dimensional weight tensor;
factorizing, during the training, the weight tensor to the codebook matrix and the latent matrix;
quantizing, during the training, the codebook matrix and the latent matrix.

5. The processor-implemented method of claim 4, further comprising factorizing the weight tensor to the codebook matrix and the latent matrix based on a floating point implementation for principal component analysis (PCA).

6. The processor-implemented method of claim 4, further comprising optimizing, during the training, the codebook matrix and the latent matrix on training data based on quantizing the dense matrix and the sparse matrix.

7. The processor-implemented method of claim 4, in which a compression rate of a factorization associated with the codebook matrix is different from a compression rate of a factorization associated with the latent matrix.

8. The processor-implemented method of claim 1, in which the codebook matrix and the latent matrix are stored in a memory associated with a device that implements the ANN.

9. The processor-implemented method of claim 1, in which the layer is a convolutional layer or a fully connected layer.

10. The processor-implemented method of claim 1, in which the latent matrix is a sparse quantized matrix and the codebook matrix is a dense quantized matrix.

11. An apparatus for an artificial neural network (ANN), comprising:
means for retrieving, for a layer of the ANN, a codebook matrix representing a codebook and a latent matrix representing linear coefficients;
means for determining, for the layer, the weight tensor based on a product of the codebook matrix and the latent matrix; and
means for processing, at the layer, an input based on the weight tensor.

12. The apparatus of claim 11, further comprising means for repeating, for each remaining layer of the set of layers, the means for retrieving, the means for determining, and the means for processing based on a codebook matrix and a latent matrix associated with a weight tensor of each remaining layer of the set of layers.

13. The apparatus of claim 11, in which the means for processing the input comprises means for performing a convolution based on weights associated with the weight tensor.

14. The apparatus of claim 11, further comprising:
means for generating, during training of the ANN, the weight tensor based on a transformation of an original weight tensor from a four-dimensional weight tensor to a two-dimensional weight tensor;
means for factorizing, during the training, the weight tensor to the codebook matrix and the latent matrix;
means for quantizing, during the training, the dense matrix and the latent matrix; and
means for sparsifying the latent matrix.

15. The apparatus of claim 14, further comprising means for factorizing the weight tensor to the dense matrix and the sparse matrix based on a floating point implementation for principal component analysis (PCA).

16. The apparatus of claim 14, further comprising means for optimizing, during the training, the codebook matrix and the latent matrix on training data based on the quantizing.

17. The apparatus of claim 14, in which a compression rate of a factorization associated with the codebook matrix is different from a compression rate of a factorization associated with the latent matrix.

18. The apparatus of claim 11, in which the codebook matrix and the latent matrix are stored in a memory associated with a device that implements the ANN.

19. The apparatus of claim 11, in which the layer is a convolutional layer or a fully connected layer.

20. The apparatus of claim 11, in which the latent matrix is a sparse quantized matrix and the codebook matrix is a dense quantized matrix.

21. An apparatus for an artificial neural network (ANN), comprising:
a processor;
a memory coupled with the processor; and
instructions stored in the memory and operable, when executed by the processor, to cause the apparatus to:
retrieve, for a layer of the ANN, a codebook matrix representing a codebook and a latent matrix representing linear coefficients;
determine, for the layer, the weight tensor based on a product of the codebook matrix and the latent matrix; and
process, at the layer, an input based on the weight tensor.

22. The apparatus of claim 21, in which execution of the instructions further causes the apparatus to repeat, for each remaining layer of the set of layers, the instructions that cause the apparatus to retrieve, determine, and process based on a codebook matrix and a latent matrix associated with a weight tensor of each remaining layer of the set of layers.

23. The apparatus of claim 21, in which the instructions that cause the apparatus to process the input comprise instructions that cause the apparatus to perform a convolution based on weights associated with the weight tensor.

24. The apparatus of claim 21, in which execution of the instructions further causes the apparatus to:
generate, during training of the ANN, the weight tensor based on a transformation of an original weight tensor from a four-dimensional weight tensor to a two-dimensional weight tensor;
factorize, during the training, the weight tensor to the codebook matrix and the latent matrix;
quantize, during the training, the codebook matrix and the latent matrix.

25. The apparatus of claim 24, in which execution of the instructions further causes the apparatus to factorize the weight tensor to the codebook matrix and the latent matrix based on a floating point implementation for principal component analysis (PCA).

26. The apparatus of claim 24, in which execution of the instructions further causes the apparatus to optimize, during the training, the codebook matrix and the latent matrix on training data based on the quantizing.

27. The apparatus of claim 24, in which a compression rate of a factorization associated with the codebook matrix is different from a compression rate of a factorization associated with the latent matrix.

28. The apparatus of claim 21, in which the codebook matrix and the latent matrix are stored in a memory associated with a device that implements the ANN.

29. A non-transitory computer-readable medium having program code recorded thereon for an artificial neural network (ANN), the program code executed by a processor and comprising:
program code to retrieve, for a layer of the ANN, a codebook matrix representing a codebook and a latent matrix representing linear coefficients;
program code to determine, for the layer, a weight tensor based on a product of the codebook matrix and the latent matrix; and
program code to process, at the layer, an input based on the weight tensor.
